(19) United States
(12) Patent Application Publication
(10) Pub. No.: US 2025/0328442 A1
(43) Pub. Date: Oct. 23, 2025

(54) PREDICTIVE DIAGNOSTICS IN HIGH-PERFORMANCE COMPUTING

(71) Applicant: Hewlett Packard Enterprise Development LP, Spring, TX (US)

(72) Inventors: Shivaprasad Ashok Metimath, Bangalore (IN); Priyanka Shankare Gowda, Bangalore (IN); Subrahmanya Vinayak Joshi, Bangalore (IN)

(21) Appl. No.: 18/751,429

(22) Filed: Jun. 24, 2024

(30) Foreign Application Priority Data
Apr. 18, 2024 (IN) 202411031240

(51) Int. Cl. G06F 11/30; G06F 11/32; G06F 11/34

(52) U.S. Cl. CPC G06F 11/3051; G06F 11/321; G06F 11/3476

(57) ABSTRACT

A development system for predictive diagnostics is provided. During operation, the system can perform a first diagnostic test on a distributed computing system based on a first restriction level indicating resource consumption of a first set of hardware units. The distributed computing system can include a plurality of computing devices with processing and memory resources. The system can generate a first log comprising a first set of parameter values indicating an output of the first diagnostic test at the first restriction level of the distributed computing system. The system can configure a first diagnostic tool with the first set of parameter values to emulate the first diagnostic test. The system can then apply the first diagnostic tool to obtain a second set of parameter values indicating an output of the first diagnostic test at a second restriction level, which can be higher than the first restriction level.

### BACKGROUND

Diagnostic tests can evaluate the performance of the resources, such as processors and memory, in a high-performance computing (HPC) environment. The HPC environment typically includes a number of computing devices facilitating the resources needed to accommodate large-scale computing. The diagnostic tests can identify potential issues that may adversely affect the performance of a computing device. Furthermore, the diagnostic tests can indicate whether the resources in the HPC environment are used efficiently.

### BRIEF DESCRIPTION OF THE FIGURES

FIG. 1A illustrates an example of an HPC environment facilitating predictive diagnostics, in accordance with an aspect of the present application.

FIG. 1B illustrates an example of an HPC environment facilitating predictive diagnostics of different hardware units, in accordance with an aspect of the present application.

FIG. 2 illustrates an example of a diagnostic tool performing predictive diagnostics in an HPC environment, in accordance with an aspect of the present application.

FIG. 3 illustrates an example of the development and execution of a diagnostic tool capable of performing predictive diagnostics in an HPC environment, in accordance with an aspect of the present application.

FIG. 4A presents a flowchart illustrating the process of a development system developing and executing a diagnostic tool capable of performing predictive diagnostics in an HPC environment, in accordance with an aspect of the present application.

FIG. 4B presents a flowchart illustrating the process of a development system developing and executing another diagnostic tool capable of performing predictive diagnostics in an HPC environment, in accordance with an aspect of the present application.

FIG. 4C presents a flowchart illustrating the process of a development system generating data for configuring a diagnostic tool capable of performing predictive diagnostics in an HPC environment, in accordance with an aspect of the present application.

FIG. 5 presents a flowchart illustrating the process of a development system training an artificial intelligence (AI) model as a diagnostic tool capable of performing predictive diagnostics in an HPC environment, in accordance with an aspect of the present application.

FIG. 6 illustrates an example of a computing system facilitating predictive diagnostics in an HPC environment, in accordance with an aspect of the present application.

FIG. 7 illustrates an example of a computer-readable medium (CRM) facilitating predictive diagnostics in an HPC environment, in accordance with an aspect of the present application.

In the figures, like reference numerals refer to the same figure elements.

### DETAILED DESCRIPTION

An HPC environment can include different types of computational resources, such as processors and memory, on which large-scale computations can be executed. The different types of resources can be evaluated using different metrics. Typically, the processors can be evaluated based on the rate of execution of operations. The rate of execution can indicate the number of operations executed within a unit of time, such as a second. On the other hand, the memory can be evaluated based on the rate of data transfer to and from the memory. The rate of data transfer can indicate the number of bytes that can be written into or read from the memory within the unit of time. Therefore, the different types of resources, such as processing and memory resources, can be evaluated using different diagnostic tests.

For example, a High-Performance Linpack (HPL) test can be used to evaluate the performance of processors, and a STREAM benchmark test (or the STREAM test) to assess the performance of the memory. The HPL test can include solving a dense system of linear equations (e.g., a large matrix equation using a set of mathematical operations), which can be a fundamental task in scientific and engineering applications. The HPL test can measure the floating-point operations per second (flops) a processor can achieve. Therefore, the evaluation metrics of the HPL test can provide a quantitative measure of computational capabilities. Furthermore, the STREAM test can determine how rapidly a computing system can perform basic memory operations, such as copying, scaling, and adding numbers. The STREAM test can measure how efficiently the memory can handle large amounts of data in bytes per second (bps) or a variation thereof, such as megabytes or gigabytes per second (Mbps or Gbps, respectively). Executing these diagnostic tests can involve stressing the resources of the HPC environment, which can be time- and resource-intensive with a high carbon footprint.

The aspects described herein address the problem of efficiently evaluating the performance of different hardware units of an HPC environment by (i) obtaining empirical parameter values generated by diagnostic tests performed on the hardware units restricted at low-utilization levels; (ii) configuring a set of diagnostic tools capable of inferring the performance evaluations of the diagnostic tests based on the empirical parameter values; and (iii) determining the performance evaluations of the diagnostic tests on the hardware units restricted at high-utilization levels from the diagnostic tools. Because the physical resources of the HPC environment are used at lower restriction levels (e.g., restricted at a 50% utilization level), the empirical parameter values can be generated with low overhead. Subsequently, the empirical parameter values can be used to configure the diagnostic tools to determine the inferred parameter values at high restriction levels without physically stressing the resources.

The HPC environment can be facilitated by a distributed computing system where the computing resources in an HPC environment can be distributed among a plurality of computing devices. Currently, diagnostic tests, such as the HPL test and STREAM test for processing and memory resources, respectively, can be performed on the aggregated resources of the HPC environment. For example, when a diagnostic test is performed on processors, the total number of available processor cores is considered. Similarly, when a diagnostic test is performed on the memory, the unified memory of the computing devices is considered. When a diagnostic test is executed, a user can define a restriction level, which can indicate a maximum threshold level of the corresponding resource the diagnostic test is allowed to access. In other words, the use of physical resources can be restricted to the threshold level, such as a maximum number of processor cores or a maximum amount of memory. In this way, the diagnostic test can execute on a restricted resource space and evaluate the performance of that resource space.

When the diagnostic test is executed on the restricted resource space, the performance parameters (e.g., flops for processors, bps for memory, etc.), are collected and stored in a log. The log can be a data file comprising the performance parameter values reflective of the outcome of the execution of the diagnostic test. Typically, the diagnostic tests are often executed at a high restriction level (e.g., at around ninety percent utilization of processors and memory) to stress the processing and memory resources. However, since the HPC environment can deploy large-scale and high-capacity processing and memory resources, executing the diagnostic tests at a high utilization can be time- and resource-intensive due to the intricate and comprehensive nature of the diagnostic tests. In addition, performing the diagnostic tests at a high restriction level may lead to heightened wear and tear on the hardware (e.g., due to extensive exposure to stress).

Because running these diagnostic tests can be time- and resource-intensive, they may not be executed frequently. As a result, there can be issues that may remain undetected between the executions of these tests. Consequently, the HPC environment may incur preventable service outages and compromised user experiences. Furthermore, running such diagnostic tests can lead to unproductive use of the resources. If additional demand for resources arises while the HPC environment is stressed at a high restriction level, the HPC environment may not be able to accommodate the additional demand. Moreover, performing the diagnostic tests may lead to substantial energy consumption and environmental impact due to high resource usage. Therefore, using a large number of processors and memory components for the diagnostic tests can have a significant carbon footprint.

To address these issues, the diagnostic tests can be executed at a lower restriction level (e.g., at a fifty percent utilization level) of the computing resources. For instance, diagnostic tests can initially be executed using X percent of the available resources. In other words, the execution of the diagnostic tests can be restricted to X percent of available resources. This percentage value can be referred to as a “restriction level.” Therefore, if the percentage of resources is increased by Y for subsequent execution, the diagnostic tests can then be executed at a restriction level of (X+Y). The diagnostic tests can generate a set of parameter values indicating the performance of the hardware units at the corresponding restriction level.

For example, when a diagnostic test, such as the HPL test, is performed on the processors at a restriction level of X percent, the maximum number of processors used by the diagnostic test can be restricted to the X percent of processor cores in the HPC environment. The parameter values generated by the diagnostic test can be expressed in flops and stored in a log. On the other hand, when another diagnostic test, such as the STREAM test, is performed on the memory at a restriction level of X percent, the maximum amount of memory used by the diagnostic test can be restricted to X percent of total memory in the HPC environment. The parameter values generated by the diagnostic test can be expressed in bps and stored in another log.

A script, such as a file reading script, can be executed with the log as an input. The script can read a respective line of the log, parse the line, and extract the parameter values indicative of the corresponding performance of the HPC environment. A diagnostic tool, which can be a performance emulator tool, can then be configured using the parameter values generated by a corresponding diagnostic test. For example, two different diagnostic tools can be developed to emulate the operations of HPL and STREAM tests. In some examples, the diagnostic tools can be based on Artificial intelligence (AI) models trained on the parameter values. When the AI models are trained based on the parameter values, the AI models can be used as the diagnostic tools, which can then be used to infer the parameter values at higher restriction levels. These restriction levels can include utilization levels of seventy percent and above.

In this way, the diagnostic tools can then be used to infer the performance and diagnostics of the HPC environment under higher restriction levels, thereby facilitating predictive diagnostics at the high restriction levels in the HPC environment. Since the physical hardware resources of the HPC environment are not placed under high utilization for predictive diagnostics, the computing resources can remain available. Furthermore, predictive diagnostics can be a sustainable solution because the carbon footprint of the diagnostic process can be significantly reduced. In particular, fewer hardware units remain operational at a lower restriction level than at a higher restriction level. Hence, the power consumption of the hardware units at a low restriction level is less than the power consumption of the hardware units at a high restriction level.

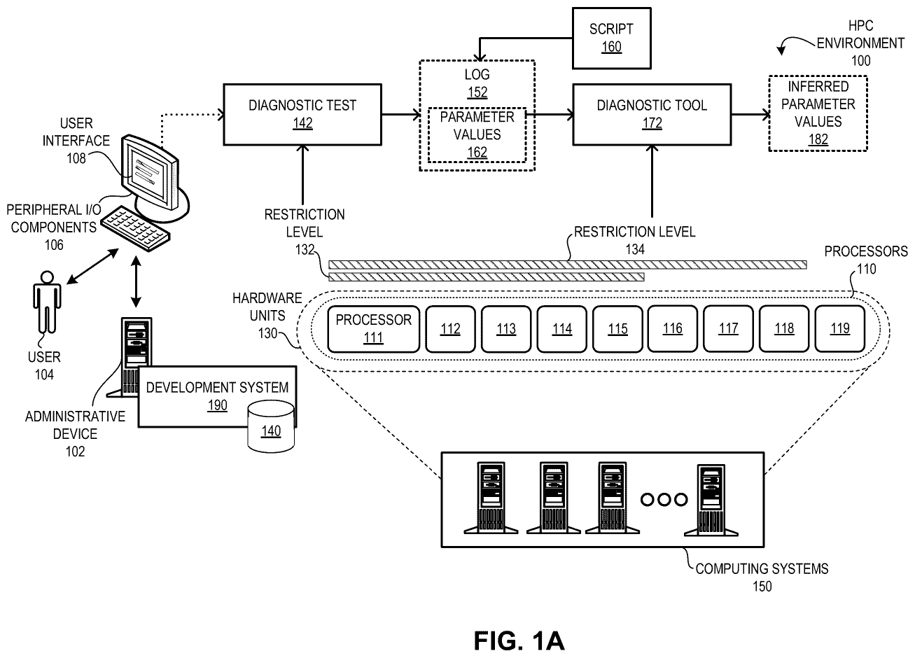

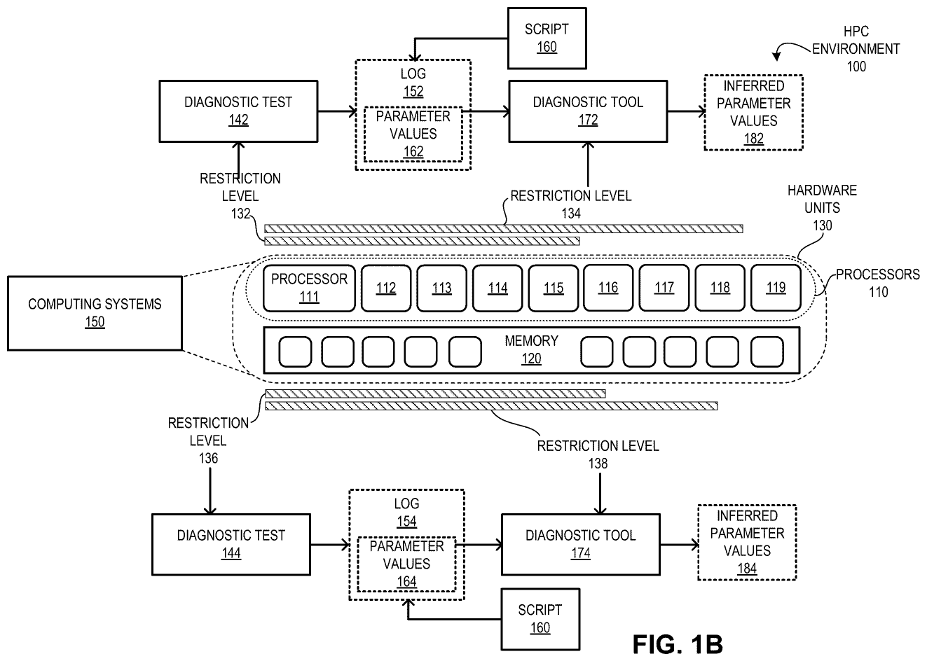

FIG. 1A illustrates an example of an HPC environment facilitating predictive diagnostics, in accordance with an aspect of the present application. An HPC environment 100 can include a number of computing devices 150 facilitating the resources needed to accommodate large-scale computing. The resources can include hardware units 130. In this example, hardware units 130 can include processing resources, such as a set of processors 110. Processors 110 can include processors 111, 112, 113, 114, 115, 116, 117, 118, and 119, and may include more processors not shown in FIG. 1A. Here, a respective processor can be a processing unit, which can be a standalone processor or a core of a processor. Processors 110 can be distributed across computing devices 150. Therefore, processors 110 can represent the aggregated processing resources of HPC environment 100. In this way, computing devices 150 can operate as a distributed computing system that can operate based on unified processing resources facilitated by processors 110.

HPC environment 100 can include an administrative device 102 with an associated user 104 and associated peripheral input/output (I/O) components 106, e.g., a display, a keyboard, a mouse (not shown), etc. Administrative device 102 can have administrative access in HPC environment 100. The administrative access can allow user 104 to perform administrative operations, such as running a diagnostic test, in HPC environment 100. User 104 can communicate with device 102 via components 106. User 104 may type or enter a command using peripheral I/O components 106, which can cause device 102 to initiate a diagnostic test 142 that can evaluate the performance of processors 110. Diagnostic test 142 can identify potential issues that may adversely affect the performance of one or more computing devices in HPC environment 100. Furthermore, diagnostic test 142 can indicate whether processors 110 are used efficiently.

Diagnostic test 142 can be an HPL test that can include performing a set of computations. The computations may include solving a dense system of linear equations (e.g., a large matrix equation using a set of mathematical operations). Accordingly, diagnostic test 142 can measure the flops processors 110 can achieve while performing the computations. In this way, diagnostic test 142 can provide a quantitative measure of the computational capabilities of processors 110. When user 104 initiates diagnostic test 142, user 104 can provide a restriction level 132, which can indicate the number of processors that diagnostic test 142 is allowed to access. Therefore, restriction level 132 can indicate the limit of resource consumption of processors 110 when diagnostic test 142 executes. For example, restriction level 132 can indicate that diagnostic test 142 is restricted to execute on sixty percent of processors 110. Hence, diagnostic test 142 can execute on processors 111, 112, 113, 114, and 115. These processors form the restricted processing resource space for diagnostic test 142.

When diagnostic test 142 is executed at restriction level 132, resultant parameter values 162 can be measured. Parameter values 162 can include flops achieved by processors 111, 112, 113, 114, and 115. Diagnostic test 142 can write parameter values 162 into a log 152. Log 152 can be a data file comprising parameter values 162. Hence, log 152 can represent the performance evaluation obtained by executing diagnostic test 142. Furthermore, diagnostic test 142 can be executed at a high restriction level 134 (e.g., at around ninety percent utilization of processors 110) to stress processors 110. Hence, diagnostic test 142 can execute on processors 111, 112, 113, 114, 115, 116, 117, and 118. However, since HPC environment 100 can deploy large-scale and high-capacity processors, executing diagnostic test 142 at restriction level 134 can be time- and resource-intensive due to the intricate and comprehensive nature of diagnostic test 142.

In addition, performing diagnostic test 142 at restriction level 134 may lead to heightened wear and tear on processors due to extensive exposure to stress. Therefore, diagnostic test 142 may not be executed frequently. As a result, there can be issues that may remain undetected between the executions of diagnostic test 142. Consequently, processors 110 may incur preventable issues. Furthermore, running such diagnostic test 142 can lead to unproductive use of processors 110. If additional demand for processing resources arises while diagnostic test 142 is running at restriction level 134, the additional demand may not be accommodated. Moreover, performing diagnostic test 142 at restriction level 134 may lead to substantial energy consumption and a significant carbon footprint due to high resource usage.

To address these issues, device 102 can run a development system 190 that can provide a framework for developing and executing a diagnostic tool that can emulate the operations of diagnostic test 142 at high restriction levels, such as restriction level 134. Device 102 can present a user interface 108, which can be facilitated by system 190, on the display. User 104 may type or enter a command into user interface 108 using peripheral I/O components 106, which can cause device 102 to initiate, from system 190, a diagnostic test 142 at restriction level 132 on processors 110. Therefore, when diagnostic test 142 is performed on processors 110 at restriction level 132, the maximum number of processors used by diagnostic test 142 can be restricted accordingly. Parameter values 162 generated by diagnostic test 142 can be expressed in flops. System 190 can store parameter values 162 in log 152. Log 152 can be stored in a persistent storage device of device 102. System 190 can execute script 160 on log 152. Script 160 can read the lines of log 152 and extract parameter values 162 from log 152.

In some examples, parameter values 162 can be stored in a persistent database 140 of device 102. Persistent database 140 can be a relational database operating on a Database Management System (DBMS). Subsequently, diagnostic tool 172, which can be a performance emulator tool emulating diagnostic test 142, can be configured using parameter values 162. To do so, system 190 can retrieve parameter values 162 from persistent database 140 (e.g., based on a query) and configure diagnostic tool 172 based on parameter values 162. System 190 can train an AI model on parameter values 162. The AI model can be a machine learning (ML) model, such as autoregressive integrated moving average (ARIMA), Seasonal ARIMA (SARIMA), Prophet, or Holt-Winters model. The trained AI model can then operate as a diagnostic tool 172.

System 190 can then use diagnostic tool 172 to emulate diagnostic test 142 at restriction level 134 and infer parameter values 182 at restriction level 134 without physically performing the computations on processors 110. Subsequently, system 190 can generate a visualized representation (e.g., a graph or a chart) of parameter values 182. Device 120 can present the visualized representation of parameter values 182 on a visualization dashboard of user interface 108. User 104 can then analyze parameter values 182 and may take actions based on parameter values 182 inferred by diagnostic tool 172.

In this way, diagnostic tool 172 can facilitate predictive diagnostics on processors 110 under higher restriction levels, such as restriction level 134. Here, the physical processors of HPC environment 100 are not placed under the stress of high utilization when diagnostic tool 172 performs predictive diagnostics. Consequently, processors 110 are not exhausted due to the execution of diagnostic test 142. Furthermore, predictive diagnostics based on diagnostic tool 172 can be a sustainable solution because the carbon footprint of diagnostic tool 172 can be significantly less than that of diagnostic test 142. In particular, fewer processors can remain operational at restriction level 132 than at restriction level 134. Hence, the power consumption of processors 110 at restriction level 132 is less than that of processors 110 at restriction level 134.

FIG. 1B illustrates an example of an HPC environment facilitating predictive diagnostics of different hardware units, in accordance with an aspect of the present application. Hardware units 130 of HPC environment 100 can also include memory resources, such as memory 120. Memory 120 can represent the unified memory of computing systems 150. Hence, memory 120 can include memory units, such as dual in-line memory modules (DIMMs), of computing systems 150. Typically, processors 110 and memory 120 can be evaluated using different diagnostic tests. For example, diagnostic test 142 (e.g., the HPL test) can be used to evaluate the performance of processors 110, and diagnostic test 144 (e.g., the STREAM test) can be used to assess the performance of memory 120. Diagnostic test 144 can determine how rapidly computing systems 150 can perform basic memory operations, such as copying, scaling, and adding numbers. Hence, diagnostic test 144 can measure how efficiently memory 120 can handle large amounts of data in bps.

Suppose that diagnostic test 144 is performed on memory 120 at a restriction level 136. Restriction level 136 can indicate a utilization level of memory 120 that diagnostic test 144 is allowed to access. Restriction level 136 can be the same as restriction level 132 or distinct from it. For example, restriction level 136 can indicate that diagnostic test 144 is restricted to execute on sixty percent of memory 120. Hence, the maximum amount of memory used by diagnostic test 144 can be restricted to sixty percent of memory 120. When diagnostic test 144 is executed at restriction level 136, resultant parameter values 164 can be measured. Parameter values 164 can include the data operation rate (e.g., in bps) achieved by memory 120 restricted at restriction level 136. Diagnostic test 144 can write parameter values 164 into a log 154, which can be a data file comprising parameter values 164, which can be expressed in bps. Here, log 154 can represent the performance evaluation obtained by executing diagnostic test 144.

Script 160 can then be executed on log 154. Script 160 can read the lines of log 154 and extract parameter values 164. Subsequently, diagnostic tool 174, which can be a performance emulator tool emulating diagnostic test 144, can be configured using parameter values 164. Diagnostic tool 174 can be based on an AI model (e.g., an off-the-shelf ML model) trained on parameter values 164. Instead of executing diagnostic test 144 at a high restriction level 138, diagnostic tool 174 can be used to emulate diagnostic test 144 at restriction level 138. Restriction level 138 can be the same as restriction level 134 or distinct from it. Here, diagnostic tool 174 can infer parameter values 184 without physically performing memory transfers on memory 120 at restriction level 138. Diagnostic tool 174 can thus perform predictive diagnostics efficiently and sustainably on memory 120 under higher restriction levels, such as restriction level 138. In this way, different diagnostic tools 172 and 174 can be used to infer the performance of processors 110 and memory 120, respectively.

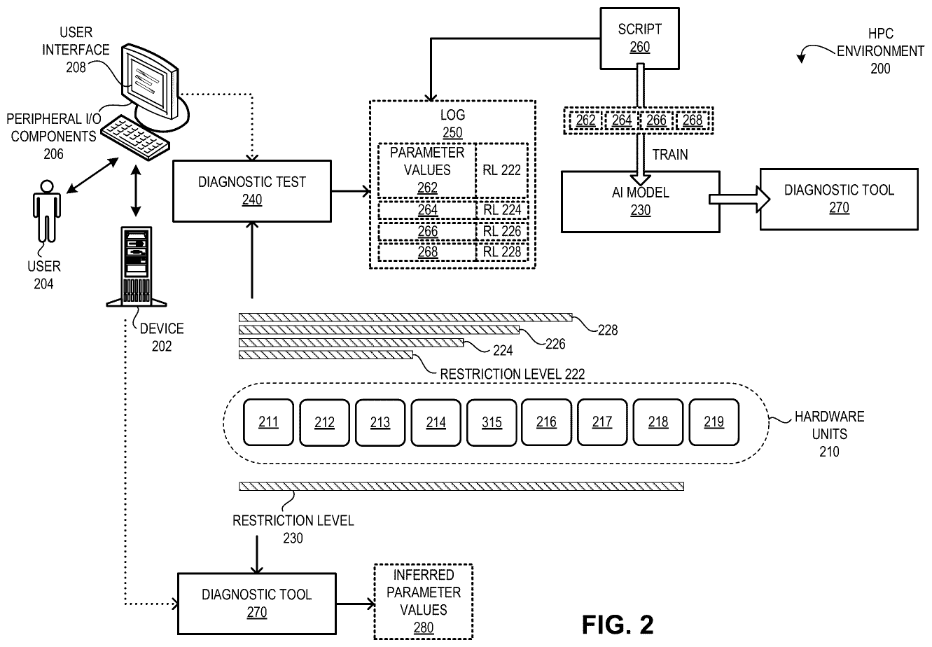

FIG. 2 illustrates an example of a diagnostic tool performing predictive diagnostics in an HPC environment, in accordance with an aspect of the present application. An HPC environment 200 can include a number of computing devices facilitating the resources needed to accommodate large-scale computing. The resources can include hardware units 210. Hardware units 210 can include units 211, 212, 213, 214, 215, 216, 217, 218, and 219, and may include more units not shown in FIG. 2. A hardware unit can be a processing unit (e.g., a processor core) or a memory unit (e.g., a DIMM). Hardware units 210 can be distributed across the computing devices of HPC environment 200. Therefore, hardware units 210 can represent the aggregated processing resources of HPC environment 200.

HPC environment 200 can include an administrative device 202 with an associated user 204 and associated peripheral I/O components 206, e.g., a display, a keyboard, a mouse (not shown), etc. User 204 can communicate with device 202 via components 206. Device 202 can have administrative access in HPC environment 200. The administrative access can allow user 204 to perform administrative operations, such as running a diagnostic test, in HPC environment 200. Device 202 can present a user interface 208 on the display. User 204 may type or enter a command into user interface 208 using peripheral I/O components 206, which can cause device 202 to initiate a diagnostic test 240 to evaluate the performance of hardware units 210. Diagnostic test 240 can then evaluate the performance of hardware units 210. Diagnostic test 240 can be performed at lower restriction levels to generate corresponding parameter values. The parameter values can then be used to configure a diagnostic tool 270. User 204 can then initiate the execution of diagnostic tool 270 to infer the performance of hardware units 210 at higher restriction levels.

To generate sufficient data based on which diagnostic tool 270 can be configured, diagnostic test 240 can be performed at a plurality of discrete restriction levels up to a threshold restriction level. Suppose that the threshold restriction level is restriction level 228. Diagnostic test 240 can then be performed at discrete restriction levels 222, 224, 226, and 228. The percentage can be increased at a predetermined interval Y for subsequent executions. Each execution of diagnostic test 240 can include the execution of a set of computations on hardware units 210 at discrete restriction levels 222, 224, 226, and 228. If hardware units 210 are processors, the set of computations can include solving a dense system of linear equations (e.g., a large matrix equation using a set of mathematical operations). If hardware units 210 are memory units (e.g., DIMMs), the set of computations can include memory operations, such as copying, scaling, and adding numbers.

For instance, diagnostic test 240 can initially be executed at restriction level 222 of hardware units 210. Here, execution of the set of computations can be restricted to X percent of available processing or memory resources offered by hardware units 210. This execution of diagnostic test 240 can then generate parameter values 262 indicating the performance of hardware units 210 at restriction level 222. Parameter values 262 can then be included in a segment in log 250. The segment can comprise restriction level 222 and parameter values 262. Subsequently, diagnostic test 240 can be executed at restriction level 224, which can restrict the use of hardware units 210 at (X+Y) percent. This execution of diagnostic test 240 can generate parameter values 264 indicating the performance of hardware units 210 at restriction level 224.

Diagnostic test 240 can then be executed at restriction level 226, which can restrict the use of hardware units 210 at (X+2Y) percent. This execution of diagnostic test 240 can generate parameter values 266 indicating the performance of hardware units 210 at restriction level 226. The percentage can continue to increase until diagnostic test 240 is executed at threshold restriction level 228, which can restrict the use of hardware units 210 at (X+3Y) percent. This execution of diagnostic test 240 can generate parameter values 268 indicating the performance of hardware units 210 at restriction level 228. Parameter values 264, 266, and 268 can be included in respective segments in log 250 in association with restriction levels 224, 226, and 228, respectively. Log 250 can be a single file comprising parameter values 262, 264, 266, and 268, or a set of files, each comprising one of parameter values 262, 264, 266, and 268.

Diagnostic tool 270 can be based on an AI model trained 230 on the parameter values in log 250. AI model 230 can be an ML model (e.g., a predeveloped ML model). Examples of AI model 230 can include, but are not limited to, ARIMA, SARIMA, Prophet, and Holt-Winters models. The parameter values can be extracted from log 250 to train AI model 230. Device 202 can execute script 260 on log 250, which can read the lines of log 250 and extract parameter values 262, 264, 266, and 268 from log 250. A smoothing algorithm, such as the moving average algorithm, can be applied to parameter values 262, 264, 266, and 268 to remove anomalous values. Since these anomalous values may interfere with the training of AI model 230, removing these values can improve the efficiency of the training process.

Based on the training, AI model 230 can learn how hardware units 210 operate when diagnostic test 240 is executed on them at different restriction levels. For example, if hardware units 210 are processors, AI model 230 can learn the expected flops at restriction levels 222, 224, 226, and 228 when the set of computations of diagnostic test 240 is performed. Trained AI model 230 can then operate as diagnostic tool 270. Diagnostic tool 270 may be stored as a serialized file on device 202. The serialization can convert the states of trained AI model 230 into a byte stream. Therefore, trained AI model 230 can be reloaded later with its trained states. In some examples, the serialized file can be a pickle file supported by the Python programming language.

Diagnostic tool 270 can then emulate diagnostic test 240 at a high restriction level 230. User 204 can initiate the execution of diagnostic tool 270 via user interface 208 with restriction level 230 as an input. Based on the training, diagnostic tool 270 can infer parameter values 280 at restriction level 230. For example, diagnostic tool 270 can infer at what rate (e.g., flops or bps) hardware units 210 can perform the set of computations associated with diagnostic test 240 without physically performing the computations on hardware units 210. In this way, diagnostic tool 270 can be used to facilitate predictive diagnostics on hardware units 210 under higher restriction levels, such as restriction level 230.

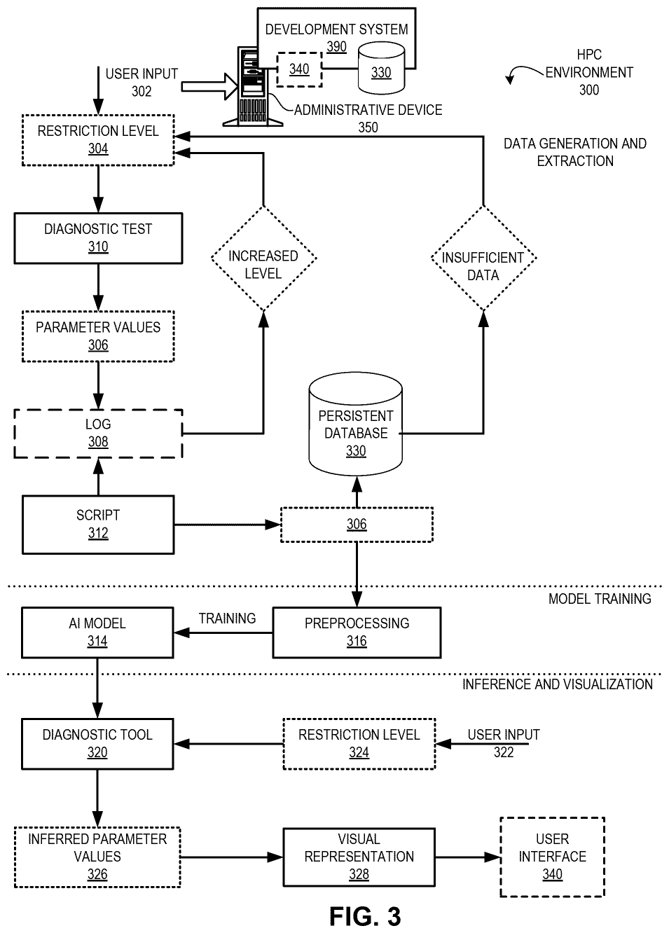

FIG. 3 illustrates an example of the development and execution of a diagnostic tool capable of performing predictive diagnostics in an HPC environment, in accordance with an aspect of the present application. An administrative device 350 can facilitate predictive diagnostics in an HPC environment 300. A development system 390 can run on device 350. Development system 390 can facilitate the development of a diagnostic tool that can emulate a diagnostic test. Predictive diagnostics can include three phases: data generation and extraction, model training, and inference and visualization. During the data generation and extraction phase, a user can provide user input 302 to administrative device 350 via a user interface 340 facilitated by system 390. User input 302 can include a command to initiate a diagnostic test 310 with a restriction level 304. System 390 can then execute diagnostic test 310 with restriction level 304 on processors or memory of HPC environment 300.

Diagnostic test 310 can generate parameter values 306 reflective of the performance of HPC environment 300 during the execution of diagnostic test 310. Parameter values 306 can be stored in log 308. System 390 may run diagnostic test 310 at discrete restriction levels increased at a predetermined interval. Each execution of diagnostic test 310 can determine corresponding parameter values 306 and incorporate them into log 308. For example, during execution, diagnostic test 310 may generate parameter values 306 in the memory of administrative device 350 and write parameter values 306 in log 308. System 390 can execute script 312 on log 308 to extract parameter values 306. Script 312 can read a respective line of log 308 and extract a corresponding parameter value from the line. System 390 can store extracted parameter values 306 in a persistent database 330, which can be a relational database. For example, database 330 can maintain one or more database tables that can store parameter values 306 in association with corresponding restriction level 304.

Subsequently, system 390 can train an AI model 314 to emulate diagnostic test 310. To train AI model 314, system 390 can retrieve parameter values 306 from database 330 based on database queries. If parameter values 306 do not include sufficient data to train AI model 314 to infer the performance evaluation provided by diagnostic test 310, system 390 can provide a prompt to the user (e.g., on user interface 340) to execute diagnostic test 310 again to generate more data required. The user can then execute diagnostic test 310 at additional restriction levels to generate parameter values, which can then be incorporated into log 308.

During the model training phase, system 390 can apply a preprocessing operation 316 on parameter values 306. Preprocessing operation 316 can include applying a smoothing algorithm, such as the moving average algorithm, on parameter values 306 to remove anomalous values. Since these anomalous values may interfere with the training of AI model 314, the removal of these values can improve the efficiency of the training process. System 390 can then train AI model 314 using the preprocessed parameter values. AI model 314 can be an ML model, such as the Holt-Winters forecasting model. Once AI model 314 is trained, it can be used as a diagnostic tool 320 that can be used to emulate diagnostic test 310. Trained AI model 314 may be stored as a serialized file on device 350. The serialized file can be reloaded at a later time with its trained states, thereby allowing it to operate as a diagnostic tool 320.

During the inference and visualization phase, diagnostic tool 320 can be used to infer parameter values 326 at high restriction levels, such as restriction level 324. For example, the user can provide user input 322, which can include a command to execute diagnostic tool 320 with restriction level 324. Based on the command, diagnostic tool 320 can infer at what rate (e.g., flops or bps) the hardware units of HPC environment 300 can perform the set of computations associated with diagnostic test 310 without physically performing the computations on the hardware units at restriction level 324. Subsequently, system 390 can present parameter values 326 in a visual representation 328. Visual representation 328 can show the performance of a particular type of hardware at different restriction levels in a line graph or bar chart.

For example, for the processors and memory in HPC environment 300, visual representation 328 may show the performance in flops and bps, respectively, at the restriction levels. Visual representation 328 may include parameter values 306 as well as parameter values 326. Visual representation 328 can also incorporate distinctive markings, such as different colors or textures, for parameter values 306 and 326. As a result, the user can distinguish the empirical and inferred parameter values. Visual representation 328 can then be displayed via user interface 340. Here, user interface 340 can be a visual interface capable of displaying visual representation 328. Examples of a visual interface can include, but are not limited to, a graphical user interface (GUI), an augmented or virtual reality interface, and a holographic interface. The user can then determine the performance of different hardware modules based on visual representation 328.

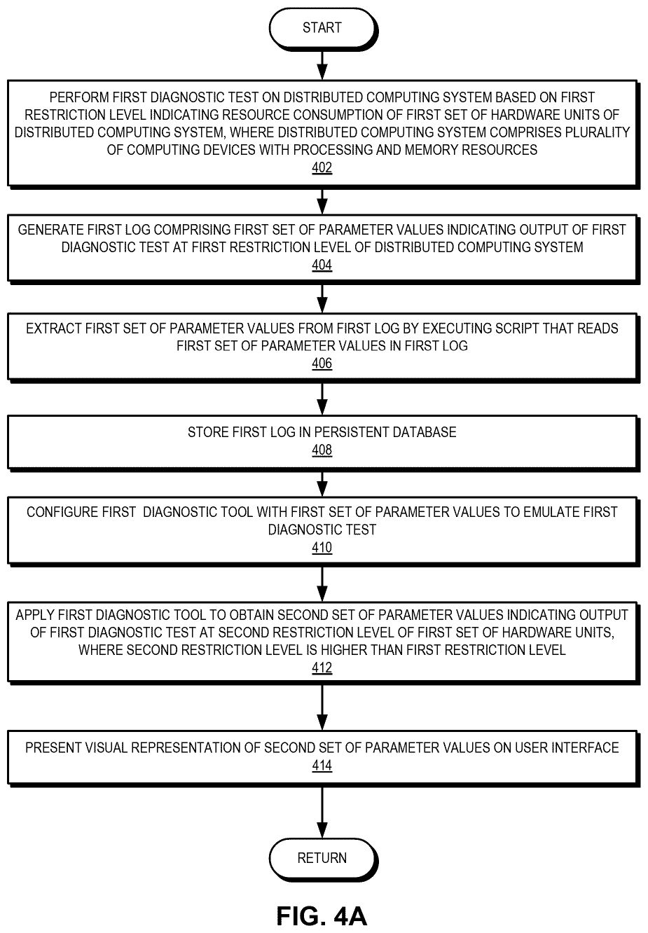

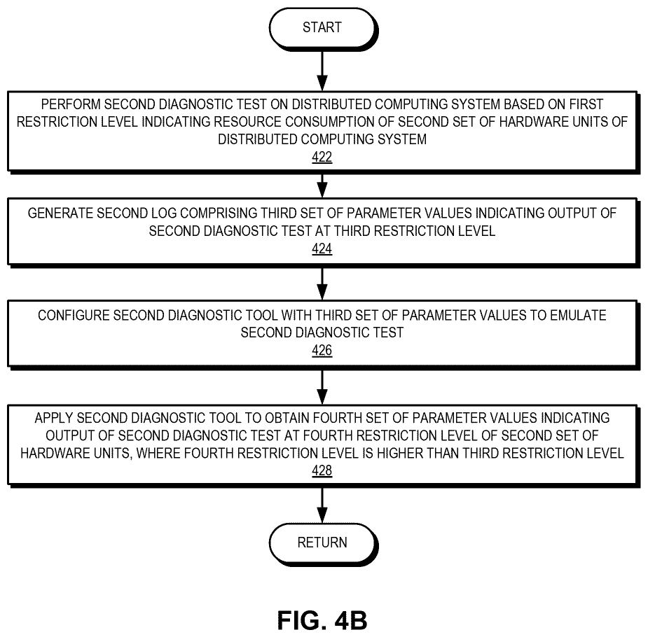

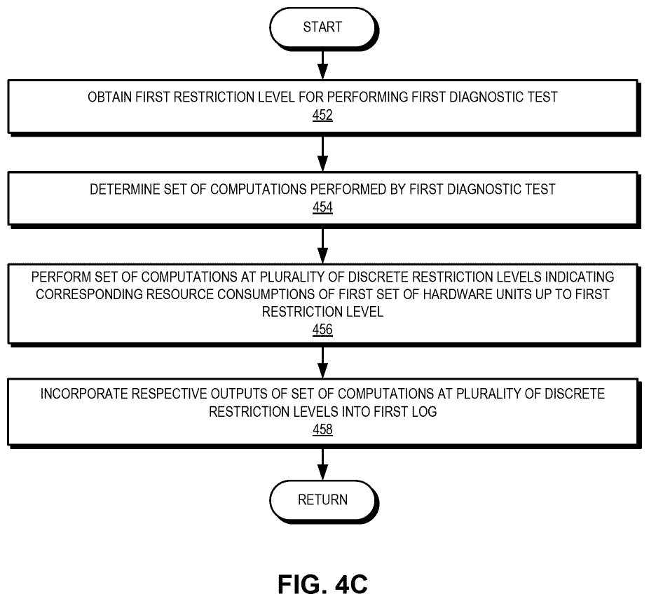

FIG. 4A presents a flowchart illustrating the process of a development system developing and executing a diagnostic tool capable of performing predictive diagnostics in an HPC environment, in accordance with an aspect of the present application. A user can initiate the development and execution process of the diagnostic tool on an administrative device running the development system. During operation, the system can perform a first diagnostic test on the distributed computing system based on a first restriction level indicating the resource consumption of a first set of hardware units of the distributed computing system (operation 402). Here, the distributed computing system comprises a plurality of computing devices with processing and memory resources. A respective computing device can be equipped with a set of processors facilitating the processing resources and one or more memory modules facilitating the memory resources. The distributed computing system can operate based on unified processing and memory resources. As a result, an application of the distributed computing system may run on the processors and memory of any of the computing devices.

The system can then generate a first log comprising a first set of parameter values indicating the output of the first diagnostic test at the first restriction level of the distributed computing system (operation 404). The first set of parameter values can be indicative of the performance of the first set of hardware units at the first restriction level. When the first diagnostic test is performed on the first set of hardware units, the first restriction level indicates the number of hardware units on which the first diagnostic test is executed. The first log can then be a file that stores the first set of parameter values in association with the first restriction level. The system can extract the first set of parameter values from the first log by executing a script that reads the first set of parameter values in the first log (operation 406). The script can read a respective line of the first log and identify a respective parameter value associated with the restriction level. Upon reading, the script may output the parameter value, thereby extracting the parameter value from the first log.

The system can store the first log in a persistent database (operation 408). Here, the persistent database can be a relational database. Therefore, the first set of parameter values in the first log can be extracted by running the script and stored in one or more database tables. The persistent database may store the first set of parameter values in association with the first restriction level. The system can then configure a first diagnostic tool with the first set of parameter values to emulate the first diagnostic test (operation 410). Since the first set of parameter values can indicate the performance of the first set of hardware units at the first restriction level, based on the configuration, the first diagnostic tool can learn how the first set of hardware units can perform when the first diagnostic test is executed at other restriction levels. Accordingly, the first diagnostic tool can emulate the first diagnostic test by determining the expected performance of the first set of hardware units at other restriction levels.

Therefore, when the configuration is complete, the first diagnostic tool can be ready to emulate the first diagnostic test. The system can then apply the first diagnostic tool to obtain a second set of parameter values indicating the output of the first diagnostic test at a second restriction level of the first set of hardware units (operation 412). Here, the second restriction level can be higher than the first restriction level. Because the first diagnostic tool can emulate the first diagnostic test, the second set of parameter values generated by the first diagnostic tool can be indicative of the output of the first diagnostic test at the second restriction level. The system can present a visual representation of the second set of parameter values on a user interface (operation 414). The system can provide the user interface. The visual representation can show the performance of the first set of hardware units at different restriction levels in a line graph or bar chart. The visual representation may include one or both of the first and second sets of parameter values.

FIG. 4B presents a flowchart illustrating the process of a development system developing and executing another diagnostic tool capable of performing predictive diagnostics in an HPC environment, in accordance with an aspect of the present application. A user can initiate the development and execution process of the other diagnostic tool on an administrative device running the development system. During operation, the system can perform a second diagnostic test on the distributed computing system based on the first restriction level indicating the resource consumption of a second set of hardware units of the distributed computing system (operation 422). The distributed computing system can include different types of hardware units, such as processing and memory units. Hence, the first set of hardware units, as described in conjunction with FIG. 4A, can be different from the first set of hardware units. Furthermore, the first and second diagnostic tests can be distinct tests applicable to the first and second sets of hardware units, respectively. For example, the first and second sets of hardware units can include processing and memory units, respectively. The first and second diagnostic tests can then evaluate the performance of processing and memory resources, respectively.

The system can then generate a second log comprising a third set of parameter values indicating the output of the second diagnostic test at a third restriction level of the distributed computing system (operation 424). The third restriction level can be the same as the first restriction level or distinct from it. The third set of parameter values can be indicative of the performance of the second set of hardware units at the first restriction level. When the second diagnostic test is performed on the second set of hardware units, the number of hardware units on which the second diagnostic test is executed is indicated by the first restriction level. The second log can then be a file that stores the third set of parameter values in association with the first restriction level. The system can extract the third set of parameter values from the second log (e.g., by executing a script that reads the third first set of parameter values in the second log).

The system can then configure a second diagnostic tool with the third set of parameter values to emulate the second diagnostic test (operation 426). Since the third set of parameter values can indicate the performance of the second set of hardware units at the first restriction level, based on the configuration, the second diagnostic tool can learn how the second set of hardware units can perform when the second diagnostic test is executed at other restriction levels. Accordingly, the first diagnostic tool can emulate the first diagnostic test by determining the expected performance of the first set of hardware units at other restriction levels. The system can then apply the second diagnostic tool to obtain a fourth set of parameter values indicating the output of the second diagnostic test at a fourth restriction level of the second set of hardware units (operation 428). Here, the fourth restriction level can be higher than the third restriction level. Furthermore, the fourth restriction level can be the same as the second restriction level or distinct from it. Because the second diagnostic tool can emulate the second diagnostic test, the fourth set of parameter values generated by the second diagnostic tool can be indicative of the output of the second diagnostic test at the second restriction level.

FIG. 4C presents a flowchart illustrating the process of a development system generating data for configuring a diagnostic tool capable of performing predictive diagnostics in an HPC environment, in accordance with an aspect of the present application. A user can initiate the data generation process for the diagnostic tool on an administrative device running the development system. During operation, the system can obtain a first restriction level for performing the first diagnostic test (operation 452). The user can provide user input to the system via a user interface facilitated by the system. The user input can include a command to initiate the first diagnostic test with the first restriction level. In this way, the system can obtain the first restriction level from the user input.

The system can determine a set of computations performed by the first diagnostic test (operation 454). If the first diagnostic test is to be performed on processing resources, the set of computations can include a dense system of linear equations (e.g., a large matrix equation using a set of mathematical operations). On the other hand, if the first diagnostic test is to be performed on memory resources, the set of computations can include memory operations, such as copying, scaling, and adding numbers. The system can then perform the set of computations at a plurality of discrete restriction levels indicating the corresponding resource consumptions of the first set of hardware units up to the first restriction level (operation 456). Here, the set of computations can be performed at each of these discrete restriction levels. Each execution of the first restriction level can include the execution of the set computations on the first set of hardware units at a corresponding restriction level.

The system can then incorporate respective outputs of the set of computations at the plurality of discrete restriction levels into the first log (operation 458). If the first diagnostic test is to be performed on processing resources, an output can be the flops processing resources can achieve at the corresponding restriction level. On the other hand, if the first diagnostic test is to be performed on memory resources, the output can indicate how efficiently the memory resources can handle data operations in bps. The system can store the outputs in the first log in association with the corresponding restriction levels.

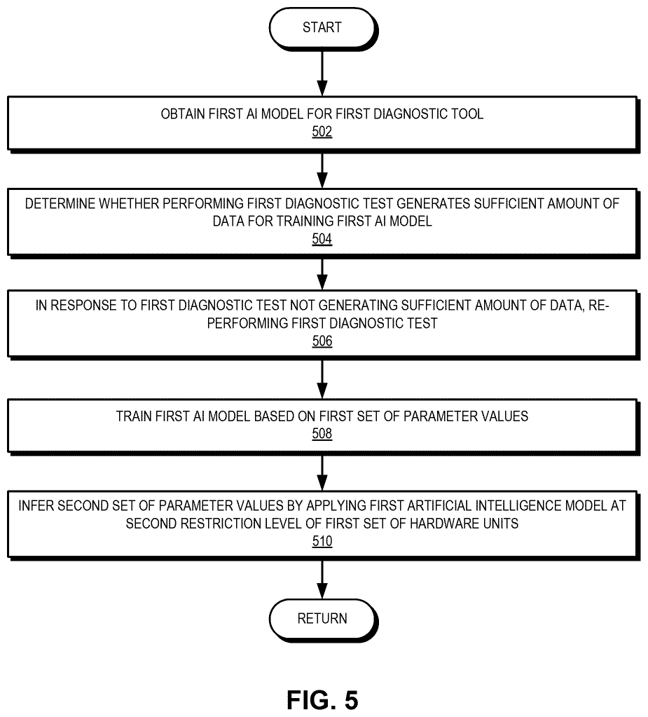

FIG. 5 presents a flowchart illustrating the process of a development system training an AI model as a diagnostic tool capable of performing predictive diagnostics in an HPC environment, in accordance with an aspect of the present application. A user can initiate the training process for the diagnostic tool on an administrative device running the development system. During operation, the system can obtain a first AI model for the first diagnostic tool (operation 502). The first AI model can be an ML model (e.g., a predeveloped ML model). Examples of the first AI model can include, but are not limited to, ARIMA, SARMIA, Prophet, and Holt-Winters models. The ML model can then be trained to forecast parameter values indicating how the first set of hardware units may perform if the first diagnostic tool is executed at a particular restriction level.

Accordingly, the system can determine whether performing the first diagnostic test generates a sufficient amount of data for training the first AI model (operation 504). If the first AI model, upon training, can infer the parameter values of the first diagnostic tool with high accuracy, the system can determine that the generated data is sufficient. Otherwise, the system can determine that more data is needed to train the first AI model further. Hence, in response to the first diagnostic test not generating a sufficient amount of data, the system can re-perform the first diagnostic test (operation 506). The additional data generated by re-performing the first diagnostic test can enhance the accuracy of the first AI model.

The system can then train the first AI model based on the first set of parameter values (operation 508). Based on the training, the first AI model can learn how the first set of hardware units operate when the first diagnostic test is executed on them at different restriction levels. For example, the first AI model can learn the expected parameter values at the first restriction level when the set of computations of the first diagnostic test is performed. The first AI model can then operate as the first diagnostic tool. The system can then infer the second set of parameter values by applying the first AI model at the second restriction level of the first set of hardware units (operation 510). The first AI model, operating as the first diagnostic tool, can emulate the first diagnostic test at the second restriction level. For example, the first AI model can infer at what rate (e.g., flops or bps) the first set of hardware units can perform the set of computations associated with the first diagnostic test without physically performing the computations on the first set of hardware units.

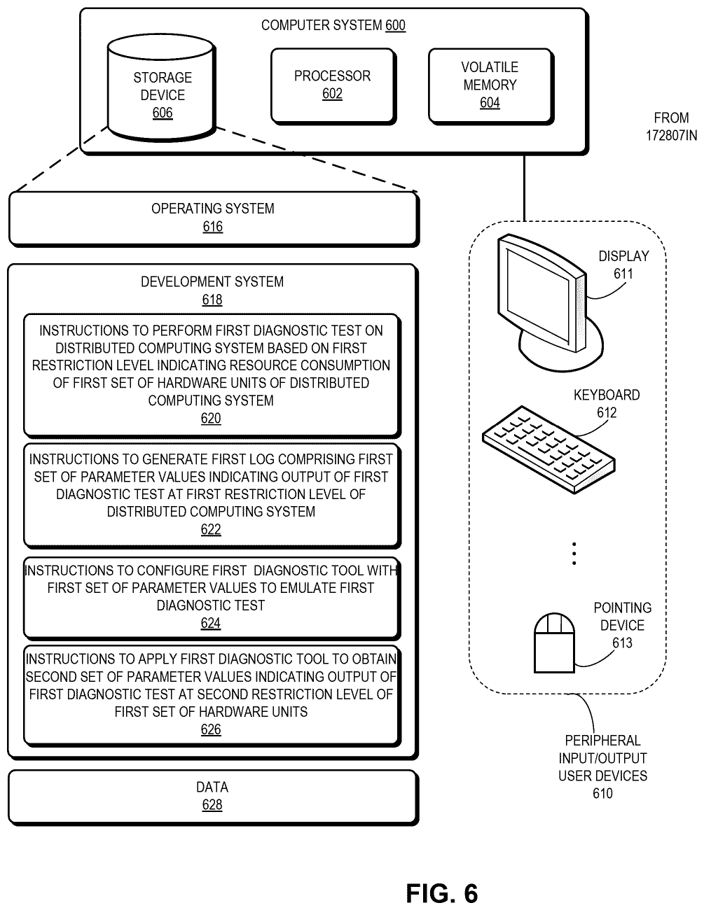

FIG. 6 illustrates an example of a computing system facilitating predictive diagnostics in an HPC environment, in accordance with an aspect of the present application. Computer system 600 includes a processor 602, a memory 604, and a storage device 606. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Storage device 606 includes a non-transitory computer-readable storage medium and stores an operating system 616, a development system 618, and data 628. Computer system 600 may include fewer or more entities or instructions than those shown in FIG. 6.

Development system 618 can include instructions, which when executed by computer system 600, can cause computer system 600 to perform methods and/or processes described in this disclosure. Specifically, development system 618 may include instructions 620 to perform a first diagnostic test on a distributed computing system based on a first restriction level indicating the resource consumption of a first set of hardware units of the distributed computing system. Here, the distributed computing system comprises a plurality of computing devices with processing and memory resources. Examples of a diagnostic test, a set of hardware units of the distributed computing system, and a restriction level are further described in conjunction with FIG. 1A. In particular, diagnostic test 142, restriction level 132, and hardware units 130 in FIG. 1A can correspond to the first diagnostic test, the first restriction level, and the first set of hardware units, respectively.

Development system 618 may also include instructions 622 to generate a first log comprising a first set of parameter values indicating the output of the first diagnostic test at the first restriction level of the distributed computing system, as described in conjunction with FIG. 1A. For example, log 152 and parameter values 162 can correspond to the first log and the first set of parameter values, respectively. The generation of the first log is further described in conjunction with log 250 of FIG. 2.

Development system 618 may include instructions 624 to configure a first diagnostic tool with the first set of parameter values to emulate the first diagnostic test, as described in conjunction with FIGS. 1A, 2, and 3. For example, an AI model can be trained using the first set of parameter values to emulate the first diagnostic test, thereby configuring the first diagnostic tool. The configuration of the first diagnostic tool is further described in conjunction with the model training phase of FIG. 3.

Development system 618 may include instructions 626 to apply the first diagnostic tool to obtain a second set of parameter values indicating the output of the first diagnostic test at a second restriction level of the first set of hardware units. Here, the second restriction level can be higher than the first restriction level, as described in conjunction with FIGS. 1A, 2, and 3. Because the first diagnostic tool can emulate the first diagnostic test, the second set of parameter values generated by the first diagnostic tool can be indicative of the output of the first diagnostic test at the second restriction level. A diagnostic tool emulating a diagnostic test to infer a set of parameter values is further described in conjunction with the inference and visualization phase of FIG. 3.

Data 628 can include any data that is required as input, or that is generated as output by the methods, operations, communications, and/or processes described in this disclosure. Specifically, data 628 can include user inputs comprising respective commands to initiate a diagnostic test, train an AI model, and apply a diagnostic tool to infer parameter values. Data 628 can also store parameter values generated by a diagnostic test at different restriction levels, a trained AI model (e.g., in a serialized form), and parameter values inferred by a diagnostic tool.

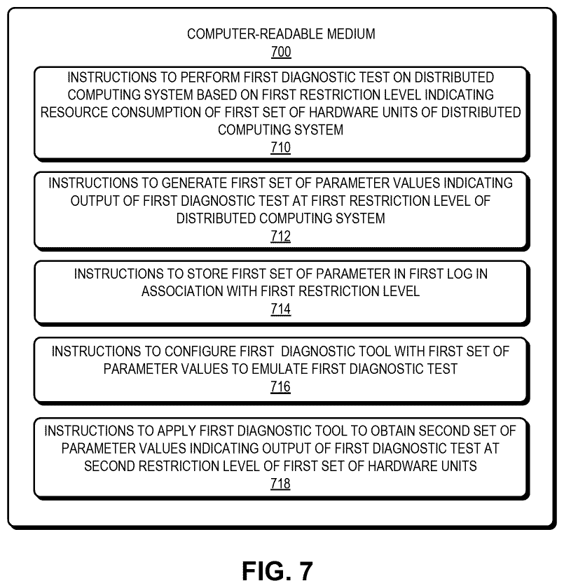

Computer system 600 and development system 618 may include more instructions than those shown in FIG. 6. For example, development system 618 can also store instructions for executing the operations described above in relation to: the HPC environment of FIGS. 1A and 1B; the development and execution of multiple diagnostic tools of FIG. 1B; the generation of parameter values at a plurality of discrete restriction levels of FIG. 2; the operations of different phases of FIG. 3; and the operations depicted in the flowcharts of FIGS. 4A-4C and 5; and the instructions of non-transitory CRM 700 in FIG. 7.

FIG. 7 illustrates an example of a CRM facilitating predictive diagnostics in an HPC environment, in accordance with an aspect of the present application. CRM 700 can be a non-transitory computer-readable medium or device storing instructions that when executed by a computer or processor cause the computer or processor to perform a method. CRM 700 can store instructions 710 to perform a first diagnostic test on the distributed computing system based on a first restriction level indicating the resource consumption of a first set of hardware units of the distributed computing system, as described above in relation to the execution of the diagnostic tests of FIG. 1A.

CRM 700 can also include instructions 712 to generate a first set of parameter values indicating the output of the first diagnostic test at the first restriction level of the distributed computing system, as described above in relation to the generation of parameter values 162 of FIG. 1A. CRM 700 can include instructions 714 to store the first set of parameter values in a first log in association with the first restriction level, as described above in relation to the generation of log 152 of FIG. 1A and log 250 of FIG. 2.

CRM 700 can additionally include instructions 716 to configure a first diagnostic tool with the first set of parameter values to emulate the first diagnostic test, as described above in relation to diagnostic tool 172 of FIG. 1A and diagnostic tool 320 of FIG. 3. CRM 700 can include instructions 718 to apply the first diagnostic tool to obtain a second set of parameter values indicating the output of the first diagnostic test at a second restriction level of the first set of hardware units, as described above in relation to diagnostic tool 172 of FIG. 1A and the inference and visualization phase of FIG. 3.

CRM 700 may include more instructions than those shown in FIG. 7. For example, CRM 700 can also store instructions for executing the operations described above in relation to: the HPC environment of FIGS. 1A and 1B; the development and execution of multiple diagnostic tools of FIG. 1B; the generation of parameter values at a plurality of discrete restriction levels of FIG. 2; the operations of different phases of FIG. 3; and the operations depicted in the flowcharts of FIGS. 4A-4C and 5; and the instructions of computer system 600 in FIG. 6.

The description herein is presented to enable any person skilled in the art to make and use the invention and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown but is to be accorded the widest scope consistent with the claims.

One aspect of the present technology can provide a development system for predictive diagnostics. During operation, the system can perform a first diagnostic test on a distributed computing system based on a first restriction level indicating resource consumption of a first set of hardware units of the distributed computing system. The distributed computing system can include a plurality of computing devices with processing and memory resources. The system can generate a first log comprising a first set of parameter values indicating an output of the first diagnostic test at the first restriction level of the distributed computing system. Subsequently, the system can configure a first diagnostic tool with the first set of parameter values to emulate the first diagnostic test. The system can then apply the first diagnostic tool to obtain a second set of parameter values indicating an output of the first diagnostic test at a second restriction level of the first set of hardware units. Here, the second restriction level can be higher than the first restriction level.

In a variation on this aspect, the system can perform a second diagnostic test on the distributed computing system based on a third restriction level indicating resource consumption of a second set of hardware units of the distributed computing system. The system can generate a second log comprising a third set of parameter values indicating an output of the second diagnostic test at the first restriction level. Subsequently, the system can configure a second diagnostic tool with the third set of parameter values to emulate the second diagnostic test. The system can then apply the second diagnostic tool to obtain a fourth set of parameter values indicating an output of the second diagnostic test at a fourth restriction level of the second set of hardware units. Here, the fourth restriction level can be higher than the third restriction level.

In a further variation, the first set of hardware units can include the processing resources of the distributed computing system, and the second set of hardware units can include the memory resources of the distributed computing system.

In a variation on this aspect, the system can extract the first set of parameter values from the first log by executing a script that reads the first set of parameter values from the first log.

In a variation on this aspect, the first diagnostic tool can be based on a first AI model. The system can then determine whether performing the first diagnostic test generates a sufficient amount of data for training the first AI model. If the first diagnostic test has not generated the sufficient amount of data, the system can re-perform the first diagnostic test.

In a further variation, the system can train the first AI model based on the first set of parameter values and infer the second set of parameter values by applying the first AI model at the second restriction level of the first set of hardware units.

In a variation on this aspect, the system can perform the first diagnostic test based on the first restriction level by performing a set of computations at a plurality of discrete restriction levels indicating corresponding resource consumptions of the first set of hardware units up to the first restriction level. The system can then incorporate respective outputs of the set of computations at the plurality of discrete restriction levels into the first log.

In a variation on this aspect, the system can store the first log in a persistent database.

In a variation on this aspect, a first power consumption of the first set of hardware units at the first restriction level can be less than a second power consumption of the first set of hardware units at the second restriction level.

In a variation on this aspect, the system can present a visual representation of the second set of parameter values on a user interface.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
performing, by a computer system, a first diagnostic test on a distributed computing system based on a first restriction level indicating resource consumption of a first set of hardware units of the distributed computing system, the distributed computing system comprising a plurality of computing devices with processing and memory resources;
generating a first log comprising a first set of parameter values indicating an output of the first diagnostic test at the first restriction level of the distributed computing system;
configuring a first diagnostic tool with the first set of parameter values to emulate the first diagnostic test; and
applying the first diagnostic tool to obtain a second set of parameter values indicating an output of the first diagnostic test at a second restriction level of the first set of hardware units, the second restriction level being higher than the first restriction level.

2. The method of claim 1, further comprising:
performing a second diagnostic test on the distributed computing system based on the first restriction level indicating resource consumption of a second set of hardware units of the distributed computing system;
generating a second log comprising a third set of parameter values indicating an output of the second diagnostic test at a third restriction level;
configuring a second diagnostic tool with the third set of parameter values to emulate the second diagnostic test; and
applying the second diagnostic tool to obtain a fourth set of parameter values indicating an output of the second diagnostic test at a fourth restriction level of the second set of hardware units, the fourth restriction level being higher than the third restriction level.

3. The method of claim 2, wherein the first set of hardware units includes the processing resources of the distributed computing system, and wherein the second set of hardware units includes the memory resources of the distributed computing system.

4. The method of claim 1, wherein extracting the first set of parameter values from the first log comprises executing a script that reads the first set of parameter values from the first log.

5. The method of claim 1, wherein the first diagnostic tool is based on a first artificial intelligence (AI) model, and wherein the method further comprises:
determining whether performing the first diagnostic test generates a sufficient amount of data for training the first AI model; and
in response to the first diagnostic test not generating the sufficient amount of data, re-performing the first diagnostic test.

6. The method of claim 5, further comprising:
training the first AI model based on the first set of parameter values; and
inferring the second set of parameter values by applying the first AI model at the second restriction level of the first set of hardware units.

7. The method of claim 1, wherein performing the first diagnostic test based on the first restriction level comprises:
performing a set of computations at a plurality of discrete restriction levels indicating corresponding resource consumptions of the first set of hardware units up to the first restriction level; and
incorporating respective outputs of the set of computations at the plurality of discrete restriction levels into the first log.

8. The method of claim 1, further comprising storing the first log in a persistent database.

9. The method of claim 1, wherein a first power consumption of the first set of hardware units at the first restriction level is less than a second power consumption of the first set of hardware units at the second restriction level.

10. The method of claim 1, further comprising presenting a visual representation of the second set of parameter values on a user interface.

11. A non-transitory computer-readable medium storing instructions to:
perform a first diagnostic test on a distributed computing system based on a first restriction level indicating resource consumption of a first set of hardware units of the distributed computing system, the distributed computing system comprising a plurality of computing devices with processing and memory resources;
generate a first set of parameter values indicating an output of the first diagnostic test at the first restriction level of the distributed computing system;
store the first set of parameter values in a first log in association with the first restriction level;
configure a first diagnostic tool with the first set of parameter values to emulate the first diagnostic test; and
apply the first diagnostic tool to obtain a second set of parameter values indicating an output of the first diagnostic test at a second restriction level of the first set of hardware units, the second restriction level being higher than the first restriction level.

12. The non-transitory computer-readable storage medium of claim 11, wherein the instructions are further to:
perform a second diagnostic test on the distributed computing system based on the first restriction level indicating resource consumption of a second set of hardware units of the distributed computing system;
generate a second log comprising a third set of parameter values indicating an output of the second diagnostic test at a third restriction level;
configure a second diagnostic tool with the third set of parameter values to emulate the second diagnostic test; and
apply the second diagnostic tool to obtain a fourth set of parameter values indicating an output of the second diagnostic test at a fourth restriction level of the second set of hardware units, the fourth restriction level being higher than the third restriction level.

13. The non-transitory computer-readable storage medium of claim 12, wherein the first set of hardware units includes the processing resources of the distributed computing system, and wherein the second set of hardware units includes the memory resources of the distributed computing system.

14. The non-transitory computer-readable storage medium of claim 11, wherein, to extract the first set of parameter values from the first log, wherein the instructions are further to execute a script that reads the first set of parameter values from the first log.

15. The non-transitory computer-readable storage medium of claim 11, wherein the first diagnostic tool is based on a first artificial intelligence (AI) model, and wherein the instructions are further to:
determine whether performing the first diagnostic test generates a sufficient amount of data for training the first AI model; and
in response to the first diagnostic test not generating the sufficient amount of data, re-perform the first diagnostic test.

16. The non-transitory computer-readable storage medium of claim 15, wherein the instructions are further to:
train the first AI model based on the first set of parameter values; and
infer the second set of parameter values by applying the first AI model at the second restriction level of the first set of hardware units.

17. The non-transitory computer-readable storage medium of claim 11, wherein, to perform the first diagnostic test based on the first restriction level, wherein the instructions are further to:
perform a set of computations at a plurality of discrete restriction levels indicating corresponding resource consumptions of the first set of hardware units up to the first restriction level; and
incorporate respective outputs of the set of computations at the plurality of discrete restriction levels into the first log.

18. The non-transitory computer-readable storage medium of claim 11, wherein the instructions are further to store the first log in a persistent database.

19. non-transitory computer-readable storage medium of claim 11, wherein the instructions are further to present a visual representation of the second set of parameter values on a user interface.

20. A computer system, comprising:
a processing resource;
a non-transitory computer-readable storage medium storing instructions that when executed by the processing resource cause the computer system to:
perform a first diagnostic test on a distributed computing system based on a first restriction level indicating resource consumption of a first set of hardware units of the distributed computing system, the distributed computing system comprising a plurality of computing devices with processing and memory resources;
store, in a first log, an output of the first diagnostic test at the first restriction level of the distributed computing system, the output comprising a first set of parameter values;
configure a first diagnostic tool with the first set of parameter values to emulate the first diagnostic test; and
execute the first diagnostic tool at a second restriction level of the first set of hardware units to obtain a second set of parameter values indicating an output of the first diagnostic test, the second restriction level being higher than the first restriction level.
